(19) United States
(12) Patent Application Publication
(10) Pub. No.: US 2002/0060244 A1
(43) Pub. Date: May 23, 2002

(54) Account settlement system and account settlement method for call sales

(75) Inventors: Kenji Tsumura, Saga-ken (JP); Kiyonori Mochizuki, Saga-ken (JP)

Correspondence Address: JORDAN AND HAMBURG LLP, 122 EAST 42ND STREET, SUITE 4000, NEW YORK, NY, 10168, US

(73) Assignee: Kentop Corporation, Saga-shi (JP)

(21) Appl. No.: 09/915,734

(22) Filed: Jul. 26, 2001

(30) Foreign Application Priority Data
Nov. 17, 2000 (JP) 2000-351785

(51) Int. Cl. G06K 15/00

(52) U.S. Cl. 235/383

(57) ABSTRACT

The problem of whether or not a product was consigned is prevented by a salesperson by reliably confirming at the time of visiting a customer the quantity of product consigned and then performing account settlement processing. The type and quantity thereof are input for all consigned products using an input means 11. After the quantity of consigned products has been confirmed by the salesperson, the total number of product types and total number of product items of the consigned products are input using the input means 11, and the total number of product types and total number of product items calculated by a calculation means 13 based on the input type and quantity of products are compared by a comparison means 14 with the input total number of product types and total number of product items. The result of the comparison is output using an output means 16. Account settlement processing is then performed by an account settlement means 15 based on the input product type and product quantity and the account settlement result is output using the output means 16.

### BACKGROUND OF THE INVENTION

1. Field of the Invention

The present invention relates to an account settlement system and an account settlement method used for settling an account relating to products delivered and consigned to a customer in the field of call sales of medical supplies and various other products.

2. Description of the Related Art

In the field of call sales of medical supplies and the like, conventionally, a system has been employed in which a medicine chest containing several types of medicines having various beneficial effects is delivered and consigned to a customer. After an appropriate time has passed, a call sales operator (referred to below as a “salesperson”) visits the customer and receives payment from the customer for those medicines that the customer has used from the medicine chest and also replenishes the supplies of the used medicines.

In call sales as above, because payment is not made at the point when the products are delivered to the customer, it is of the utmost importance that the quantity and the like of the delivered products are confirmed. However, conventionally, because the quantity and the like of the delivered products are confirmed based on a mutual relationship of trust between the customer and the medical supplies call salesperson, it is uncommon for contracts to be exchanged each time products are delivered. At most, the salesperson might have the customer put his or her signature or the like on the statement of delivery after the salesperson has confirmed the quantity of the products consigned based on the list of products on the statement of delivery.

Moreover, in the field of call sales such as this, because payment is not made at the point when the products are delivered to the customer, regardless of whether the products that the salesperson believes have been consigned are not in the customer's medicine chest, problems such as the customer insisting that he or she has not used the product or did not receive the product often arise. Such problems might be the result of a checking error by the salesperson or of a misunderstanding by the customer. In the conventional method, because it has not been possible to prove that the products were consigned, no satisfactory method has been provided to counter the problem.

### SUMMARY OF THE INVENTION

Therefore, in the present invention there are provided an account settlement system and an account settlement method for use in call sales that prevent the problem of whether or not a product has been consigned from arising by enabling a salesperson at the time the salesperson calls on a customer to reliably confirm the quantity of the product consigned to the customer and to perform the account settlement processing.

The account settlement system for use in call sales of the present invention comprises: first input means for inputting a type and quantity of a product left with a customer; second input means for inputting a total number of product types and a total number of product items of the products left with the customer; calculation means for calculating a total number of product types and a total number of product items based on the input types and quantities of products; comparison means for comparing the total number of product types and total number of product items of the products input using the second input means with the total number of product types and total number of product items calculated by the calculation means; first output means for outputting a result of the comparison by the comparison means; account settlement means for performing account settlement processing based on the type and quantity of products input using the first input means; and second output means for outputting an account settlement result by the account settlement means.

In the account settlement method for use in call sales of the present invention, a product type and product quantity are input for all consigned products; a total number of product types and a total number of product items are also input for the consigned products; the total number of product types and the total number of product items that have been calculated based on the input product type and product quantity are compared with the input total number of product types and total number of product items and a result of the comparison is output; and account settlement processing is also performed based on the input product type and product quantity and an account settlement result is output.

When calling on a customer, a salesperson inputs the type and quantity of the products being consigned to the customer and again confirms and inputting the total number of product types and total number of product items being consigned to the customer. Thus, it is possible to reliably confirm the quantity of products being consigned and to perform accurate account settlement processing the next time the salesperson calls on the customer.

In the account settlement system for use in call sales of the present invention, it is preferable that there is further provided third input means used for inputting authentication information showing that customer authentication has been obtained based on an output by the first output means, and the account settlement means performs account settlement processing based on an input of the authentication information by the third input means. Moreover, the input of the authentication information showing that customer authentication has been obtained based on the output of the comparison result is completed first and the output of the account settlement result is performed after that.

As a result of this, it is possible to acquire authentication information proving that the customer authentication has been obtained after the quantity of consigned products has been confirmed by the salesperson and it is also possible to prevent the problem of whether or not a product was consigned from arising at the account settlement processing time.

In the account settlement system for use in call sales of the present invention, it is also preferable that the first input means specifies a type of each product and calculates a quantity of each product by reading a bar code allocated in advance to each of the products.

As a result of this, the labor required to input the type and quantity of product by the salesperson as well as the labor required to do the necessary clerical work can be reduced and mistakes in the inputting by the salesperson as well as mistakes in the transcribing by a clerical worker can be prevented enabling even more reliable account settlement processing to be performed.

In the account settlement system for use in call sales of the present invention, it is also preferable that the second input means inputs the total number of product items by category when inputting both the total number of product types and the total number of product items of consigned products.

When the consigned products are medicinal products, for example, there are products that are stored in the medicine chest and products that are not stored in the medicine chest. Accordingly, by firstly inputting the total number of product types of all the consigned products and then secondly inputting the total number of product items to be input in either the category of products stored inside the medicine chest or the category of products stored outside the medicine chest, it is possible to more reliably confirm the quantity of consigned products and perform the account settlement processing.

### BRIEF DESCRIPTION OF THE DRAWINGS

FIG. 1 is a view of an overall structure of an account settlement system in an embodiment of the present invention.

FIG. 2 is a block diagram showing a functional structure of the account settlement system in the embodiment of the present invention.

FIG. 3 is a flow chart showing the processing from the consignment of products to be left with a customer until the settlement of an account for the products in the embodiment of the present invention.

FIG. 4 is a view showing an example of a confirmation screen of the total number of product types/total number of product items.

FIG. 5 is a view showing an example of a customer authentication screen.

FIG. 6 is a view showing an example of an output medicine consignment statement.

FIG. 7 is a view showing an example of an inspection screen showing how much of each consigned medicine has been used.

FIG. 8 is a view showing an example of an output invoice for the cost of the amount used.

### DESCRIPTION OF THE PREFERRED EMBODIMENTS

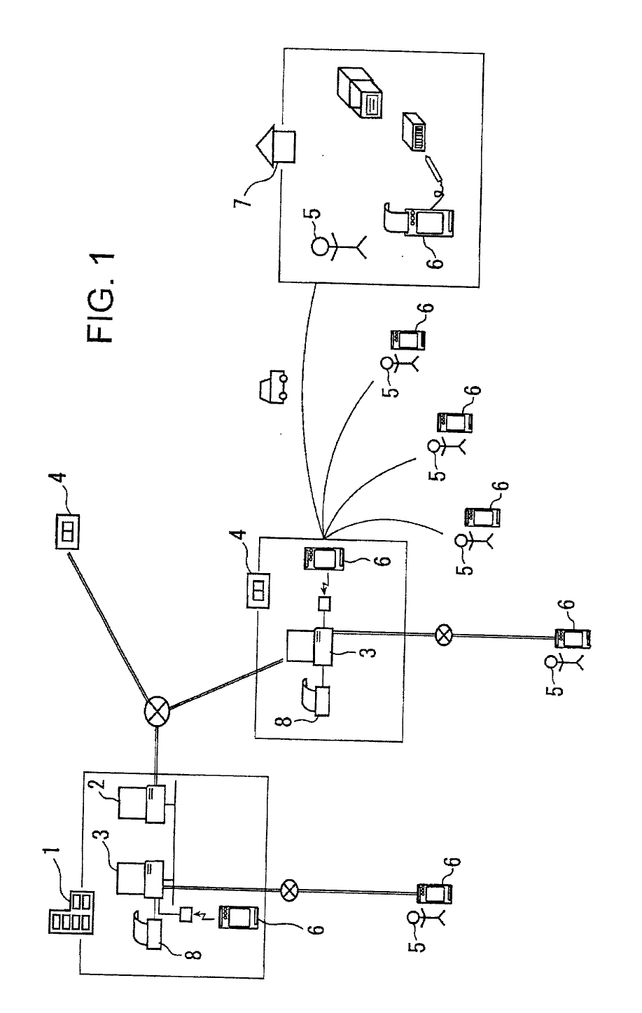

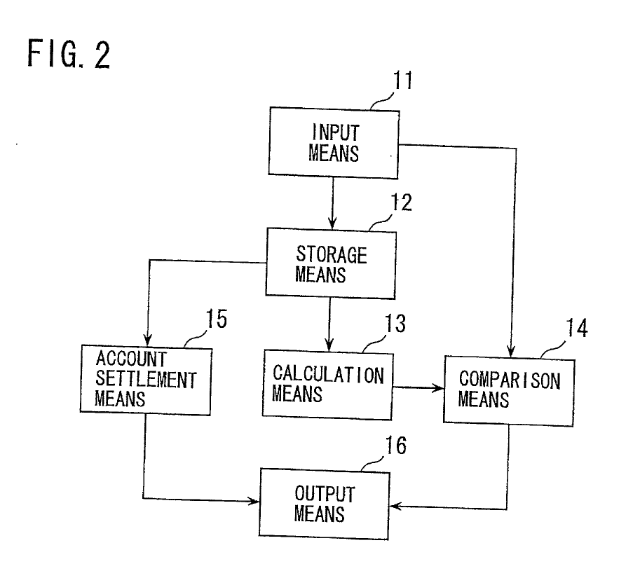

FIG. 1 is a view of an overall structure of an account settlement system in an embodiment of the present invention. FIG. 2 is a block diagram showing a functional structure of the account settlement system in the embodiment of the present invention.

As shown in FIG. 1, a server computer (referred to below as “SC”) 2 for data tabulation analysis and a personal computer serving as a client computer (referred to below as “PC”) 3 connected via a network to the server computer 2 for data communication are installed in a head office 1. The PC 3 is also installed in each sales office 4 and each salesperson 5 carries a portable input/output terminal (referred to below as “HT”) 6. When calling on a customer 7, the salesperson 5 inputs into the HT 6 all data relating to the customer such as data concerning the customer and data on the products consigned to that customer. The data input into the HT 6 is either sent immediately to the PC 3 or is later collated and then sent to the PC 3. The data sent to the PC 3 is transferred to the SC 2 and accumulated. It is also possible to output this data in print by the PC 3 on a medium such as printing paper using a printer device 8.

As shown in FIG. 2, the account settlement system of the present embodiment comprises an input means 11 for inputting such things as the type and quantity of products consigned as well as the total number of product types and total number of items of products consigned; a storage means 12 for temporarily storing the type and quantity of products and the like which have been input using the input means 11; a calculation means 13 for calculating the total number of product types and total number of product items based on the type and quantity of products stored in the storage means 12; a comparison means 14 for comparing the total number of product types and total number of product items of the products input using the input means 11 with the total number of product types and total number of product items calculated by the calculation means 13; an account settlement means 15 for performing account settlement processing based on the type and quantity of products stored in the storage means 12; and an output means 16 for outputting a result of the comparison by the comparison means 14 and an account settlement result by the account settlement means 15 and the like.

The input means 11 and the output means 16 are provided in the HT 6, while the storage means 12, the calculation means 13, the comparison means 14, and the account settlement means 15 are provided in either the HT 6 or the PC 3. The HT 6 is a mobile telephone capable of connecting to the Internet. If the storage means 12, the calculation means 13, the comparison means 14, and the account settlement means 15 cannot be formed in the mobile telephone, then the account settlement system of the present embodiment can be achieved by forming the storage means 12, the calculation means 13, the comparison means 14, and the account settlement means 15 in the PC 3 and by performing data transmission with the PC 3 whenever necessary.

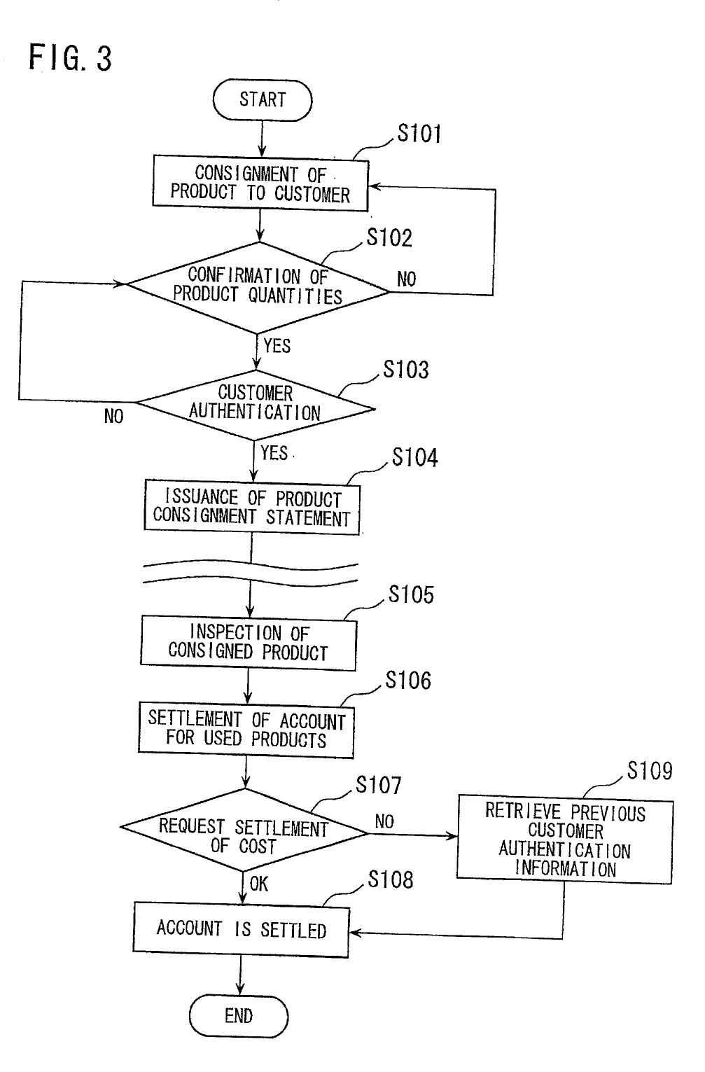

A description will now be given based on FIG. 3 of the flow showing the processing from the consignment of a medicinal product (i.e. a medicine that is left at the customer's location) serving as a call sales product consigned using the account settlement system having the structure described above. FIG. 3 is a flow chart showing the processing from the consignment of the products until the settlement of the account for the products in an embodiment of the present invention.

In step S101, the salesperson carries out the task of delivering a medicinal product that is to be consigned to a customer 7. It is assumed that a bar code including information such as expiry date and the like is assigned to the medicinal product. When the HT 6 is provided with a bar code reader, serving as the input means 11, for reading a bar code, the type and quantity of the medicinal product being left with the customer is input by the bar code reader reading the bar code of the medicinal product. Alternatively, it is also possible to input the data via input keys provided for the HT 6 that serve as the input means 11. The type and quantity of the input medicinal product are temporarily stored in the storage means 12 of the HT 6 or PC 3.

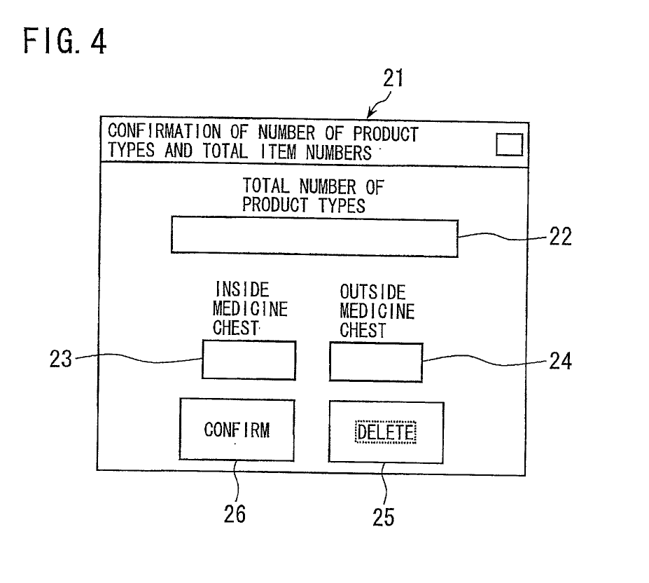

In step S102, the salesperson visually confirms the total number of product types and total number of product items of the medicinal products and these are then input using the total number of product types and total number of product items confirmation screen 21 shown in FIG. 4. As shown in FIG. 4, in the total number of product types and total number of product items confirmation screen 21, provided are a total number of product types input column 22 for inputting the total number of product types of the medicinal product as well as total number of product items input columns 23 and 24 for inputting the total number of product items respectively under the category of medicinal products that are stored in the medicine chest and the category of medicinal products that are not stored in the medicine chest. The salesperson inputs the confirmed total number of product types and total number of product items in each category into the input columns 22 to 24 using the input keys as the input means 11. If the contents that have been input into the input columns 22 to 24 are to be corrected, this is done by selecting a “Delete” button 25. When the input is completed, a “Confirm” button 26 is selected. This causes the calculation means 13 to acquire the types and quantities of the medicinal products stored in the storage means 12 and to calculate the total number of product types and total number of product items based thereon. The comparison means 14 then compares the total number of product types and total number of product items of the medicinal products input into the input columns 22 to 24 with the total number of product types and total number of product items calculated by the calculation means 13. If, as a result of the comparison, the respective total numbers of product types and total numbers of product items do not match, then the routine returns to step S101 and the processing is repeated. Accordingly, if the respective total numbers of product types and total numbers of product items do not match because of a mistake made by the salesperson or the like, this mistake can be rectified before the HT 6 moves to the next screen.

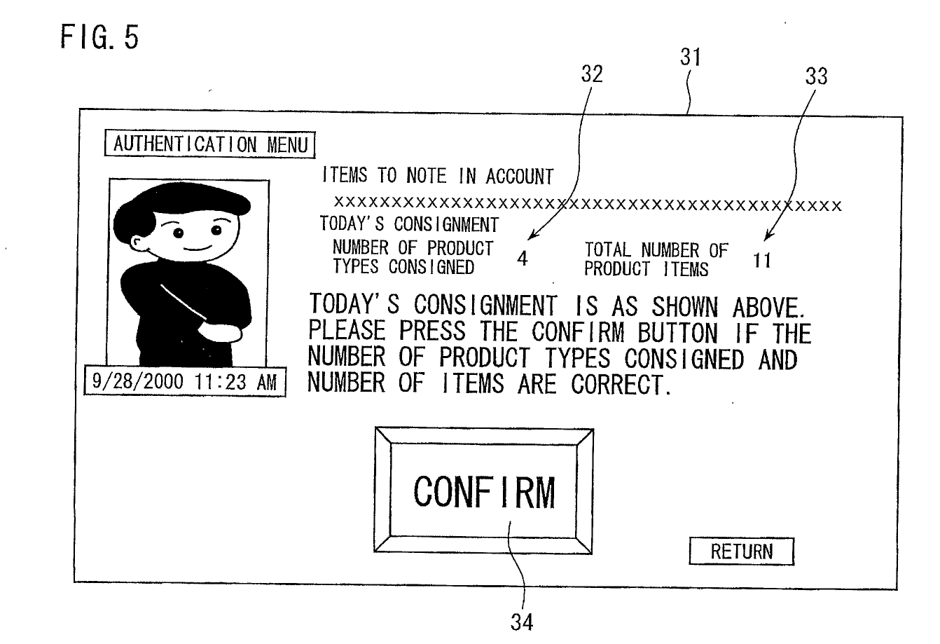

If the respective total numbers of product types and total numbers of product items do match, then in step S103 the task of authentication by the customer is carried out. FIG. 5 shows a customer authentication screen 31 output to the HT 6 and shows a total number of consigned product types 32 and a total number of consigned products items 33. When customer authentication is obtained after the customer has confirmed the customer authentication screen 31, a portrait photograph of the customer is taken using a camera or the like provided as the input means 11 in the HT 6 and the current date and time are input. The input portrait image of the customer, the date, and the time are displayed on the customer authentication screen 31. The customer then selects a “Confirm” button 34 in order to indicate that customer authentication has been obtained. The “Confirm” button 34 is a sensor used as an input means that performs fingerprint identification. Alternatively, the “Confirm” button 34 may be a means for inputting the handwritten signature or the actual voice of the customer. Whichever is used, the input confirmation is stored in the storage means 12 of the HT 6 or the PC 3 as authentication information. If the customer authentication is not obtained here, the routine returns to step S102 and the confirmation task is repeated without the HT 6 moving to the next screen. In this manner, in steps S101 and S102, because a twofold confirmation by both the salesperson and the customer is made, it is possible to prevent mistakes from being made or illegalities from being committed by the salesperson.

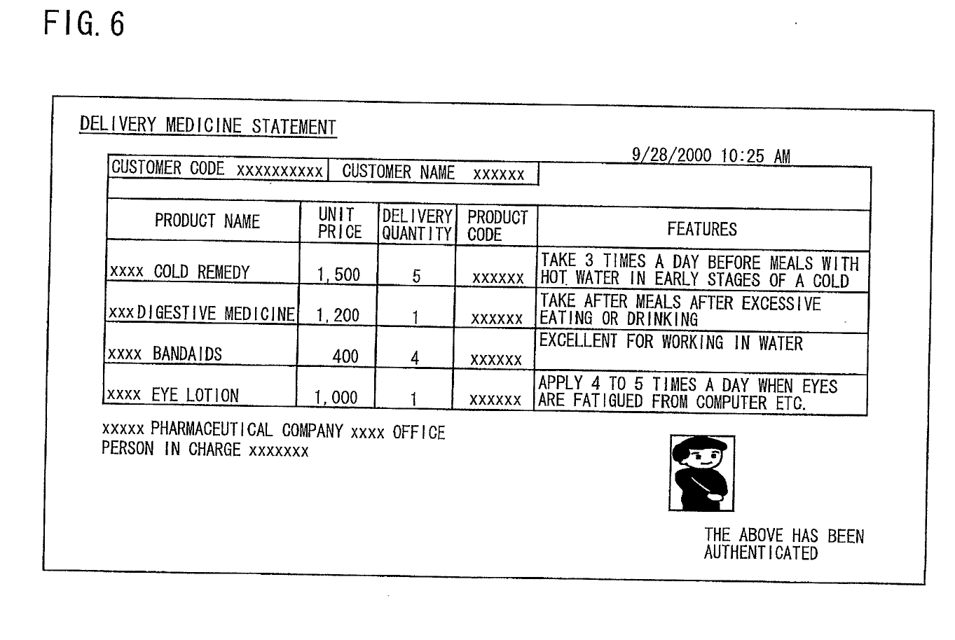

After the customer authentication is obtained, in step S104 the issuing of a product consignment statement is performed. FIG. 6 shows a medicine consignment statement output using the output means 16 of the HT 6. On the medicine consignment statement are displayed the consignment date, time, customer code, customer name, product name of the consigned medicinal product, unit price, consignment quantity, product code, features, and authentication result. The authentication information as well as the type and quantity of the medicinal product stored in the storage means 12 and the like are ultimately transferred to the SC 2 and are accumulated.

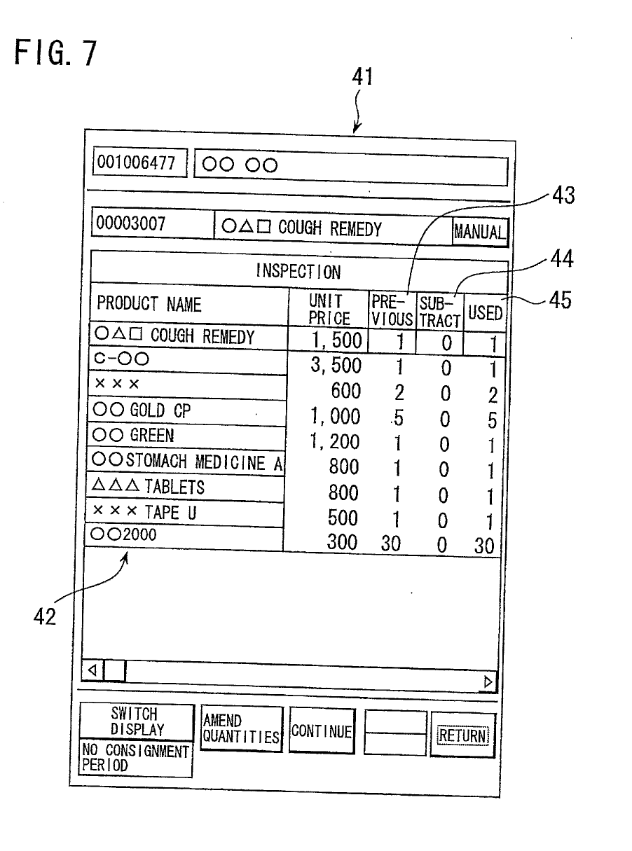

In step S105, how much of the medicine left with the customer 7 has been used by the customer 7 is inspected at the time of the next visit. FIG. 7 shows an inspection screen 41 showing how much of the consigned medicines have been used. The salesperson reads the bar code of medicines that were left with the customer and that have not been used using the bar code reader as the input means 11 of the HT 6. As a result, the type and quantity of the medicines left with the customer 7 that have not been used by the customer 7 are input into the HT 6 and stored in the storage means 12 of the HT 6 or the PC 3. As shown in FIG. 7, on the inspection screen 41 are displayed a product name 42, a quantity of product 43 left with the customer the previous time the salesperson called on the customer, a current product quantity 44, and a current used quantity 45 found by subtracting the quantity 44 from the quantity 43.

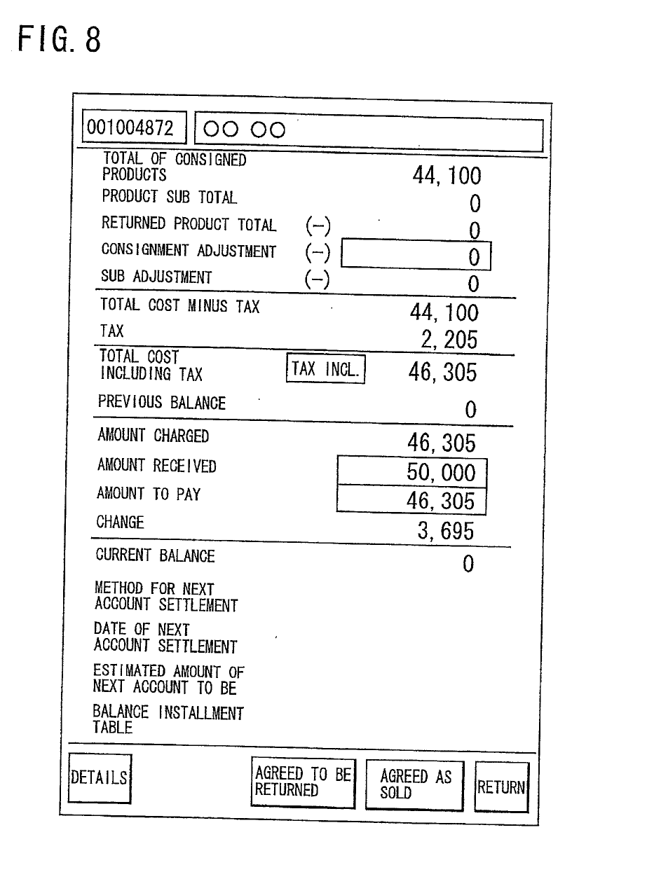

In step S106, the account settlement means 15 acquires the type and quantity of consigned medicines from the storage means 12 and automatically performs account settlement processing based on these. An invoice for the cost of the amount used such as that shown in FIG. 8 is then output by the output means 16. In step S107, this invoice is presented to the customer and, in step S108, the account is settled and a receipt is issued. Because the account settlement processing of step S106 is performed by automatic calculation, there are no mistakes in the calculation. However, if the customer's approval is not obtained in step S107, in step S109 the type and quantity of the medicinal products as well as the authentication information from the previous visit which have been stored in the PC2 are acquired by the HT 6 and are output to the screen or the like by the output means 16. These are then presented to the customer 7, the confirmation of the customer is this time obtained, and the account settlement of step S108 is performed.

As described above, when calling on the customer, the salesperson inputs the type and quantity of all medicinal products left with the customer, inputs the total number of product types and total number of product items of the medicinal products left with the customer, compares the total number of product types and total number of product items calculated on the basis of the input type and quantity of products with the input total number of product types and total number of product items, and then outputs the result of the comparison. Further, the salesperson performs the account settlement processing on the basis of the input type and quantity of the products and outputs the account settlement result. Thus, it is possible to reliably confirm the quantity of consigned products and to perform the account settlement processing reliably, and it is also possible to prevent the problem of whether or not a product was consigned from arising.

Moreover, by first completing the input of the authentication information showing that the customer authentication has been obtained based on the output of the comparison result and then outputting the account settlement result after that, it is possible to acquire authentication information proving that the customer authentication has been obtained after the quantity of consigned products has been confirmed by the salesperson, and it is possible to more reliably confirm the quantity of consigned products and perform the account settlement processing.

By performing the input of the type and quantity of medicinal products left with the customer by reading a bar code allocated in advance to each medicinal product and then specifying the type and calculating the quantity of each medicinal product based on this, the labor required to input the type and quantity of product by the salesperson as well as the labor required to do the necessary clerical work can be reduced, and mistakes in the input by the salesperson as well as mistakes in the transcribing by a clerical worker can be prevented, which enables even more reliable account settlement processing to be performed. In addition, because the total number of consigned medicinal product items is input under either the category of medicinal products that are stored in the medicine chest or under the category of medicinal products that are not stored in the medicine chest, it is possible to more reliably confirm the quantity of consigned products and perform the account settlement processing.

While the preferred form of the present invention has been described, it is to be understood that modifications will be apparent to those skilled in the art without departing from the spirit of the invention. The scope of the invention, therefore, is to be determined solely by the following claims.

What is claimed is:

1. An account settlement system for use in call sales comprising:
first input means for inputting a type and quantity of a product left with a customer;
second input means for inputting a total number of product types and a total number of product items of the products left with the customer;
calculation means for calculating a total number of product types and a total number of product items based on the input types and quantities of products;
comparison means for comparing the total number of product types and total number of product items of the products input using the second input means with the total number of product types and total number of product items calculated by the calculation means;
first output means for outputting a result of the comparison by the comparison means;
account settlement means for performing account settlement processing based on the type and quantity of products input using the first input means; and
second output means for outputting an account settlement result by the account settlement means.

2. The account settlement system for use in call sales according to claim 1 further comprising third input means used for inputting authentication information showing that customer authentication has been obtained based on an output by the first output means, the account settlement means performing account settlement processing based on an input of authentication information by the third input means.

3. The account settlement system for use in call sales according to claim 1 or 2, wherein the first input means specifies a type of each product and calculates a quantity of each product by reading a bar code allocated in advance to each of the products.

4. The account settlement system for use in call sales according to claim 1 or 2, wherein the second input means inputs the total number of product items by category.

5. An account settlement method for use in call sales in which:
a product type and product quantity are input for all consigned products;
a total number of product types and a total number of product items are also input for the consigned products;
the total number of product types and the total number of product items that have been calculated based on the input product type and product quantity are compared with the input total number of product types and total number of product items and a result of the comparison is output; and
account settlement processing is performed based on the input product type and product quantity and an account settlement result is output.

6. The account settlement method for use in call sales according to claim 5, wherein the input of the authentication information showing that customer authentication has been obtained based on the output of the comparison result is completed first and the output of the account settlement result is performed after that.
